(19) United States
(12) Patent Application Publication
(10) Pub. No.: US 2005/0253037 A1
(43) Pub. Date: Nov. 17, 2005

(54) Display apparatus

(76) Inventors: Young-tai Kim, Yongin-si (KR); Byung-jo Kano, Suwan-si (KR)

Correspondence Address: STANZIONE & KIM, LLP, 919 18TH STREET, N.W., SUITE 440, WASHINGTON, DC, 20006, US

(21) Appl. No.: 11/085,178

(22) Filed: Mar. 22, 2005

(30) Foreign Application Priority Data
May 13, 2004 (KR) 2004-33914

(51) Int. Cl. B41J 11/02

(52) U.S. Cl. 248/442.2

(57) ABSTRACT

A display apparatus includes a monitor having a through hole, a stand bracket provided inside the monitor and placed adjacent to the through hole, and a stand base provided below the monitor and detachably coupled to the stand bracket through the through hole of the monitor.

### CROSS-REFERENCE TO RELATED APPLICATIONS

This application claims the benefit of Korean Patent Application No. 2004-33914, filed on May 13, 2004, in the Korean Intellectual Property Office, the disclosure of which is incorporated herein by reference.

### BACKGROUND OF THE INVENTION

1. Field of the Invention

The present invention relates to a display apparatus, and more particularly, a display apparatus having a stand bracket and a stand base to stably support a monitor and enable the monitor to rotate at a given degree.

2. Description of the Related Art

Recently, a flat panel display, such as an LCD (Liquid Crystal Display), has been widely applied to various types of display apparatuses, such as a computer monitor or a TV, and accordingly, its demand is increased. Therefore, research and study to improve functions and efficiency of the display apparatus in various ways are actively ongoing to meet various users' needs.

A conventional display apparatus comprises a monitor displaying an image thereon, a stand base coupled to the monitor and supporting the monitor, and a stand bracket coupling the monitor and the stand base so as to enable the monitor to be rotatable. The stand bracket comprises a hinge structure to allow a user to selectively rotate the monitor if necessary.

However, the conventional display apparatus with the foregoing configuration has problems in that the stand bracket comprises a complicatedly hinge structure, and in that detaching the stand base from the stand bracket is complicated. Accordingly, working and assembling efficiencies are decreased whereas manufacturing costs are increased.

In addition, when the monitor is mounted on a wall, the stand base is detached therefrom, and a portion of the stand base is externally exposed, so that the stand base might be damaged due to an external impact while degrading an appearance of the monitor.

### SUMMARY OF THE INVENTION

In order to solve the foregoing and/or other problems, it is an aspect of the present general inventive concept to provide a display apparatus with a stand base which can be simply detached from a monitor, and a stand bracket which is not externally exposed when the monitor is mounted on a wall while the stand base is detached from the stand bracket of the monitor, and thereby preventing the stand bracket from being damaged due to an external impact and improving an appearance of the monitor.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a display apparatus comprising a monitor having a through hole, a stand bracket provided inside the monitor and placed adjacent to the through hole, and a stand base provided below the monitor and detachably coupled to the stand bracket through the through hole of the monitor.

According to an aspect of the present general inventive concept, the through hole can be formed in a lower portion of the monitor.

According to another aspect of the present general inventive concept, the stand bracket may comprise a first bracket supportably coupled to an inside of the monitor; and a second bracket rotatably connected to the first bracket and coupled to the stand base.

According to yet another aspect of the present general inventive concept, the second bracket and the stand base may respectively have at least one screw coupling groove and one corresponding screw through hole which are coupled by a screw.

According to still another aspect of the present general inventive concept, at least one of the second bracket and the stand base may have a guide groove, and the other one of the second bracket and the stand base has a guide projection corresponding to the guide groove.

According to another aspect of the present general inventive concept, the second bracket may be not externally exposed through the through hole of the monitor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating a display apparatus according to the present invention;

FIG. 2 is an exploded perspective view illustrating the display apparatus in FIG. 1;

FIG. 3 is a front view illustrating a state in which a stand base is detached from the display of FIGS. 1 and 2;

FIG. 4 is a perspective view illustrating a stand bracket of the display apparatus of FIGS. 1 and 2;

FIG. 5 is a perspective view illustrating a coupling structure of the stand bracket and the stand base of the display apparatus of FIGS. 1 and 2; and

FIG. 6 is a sectional view illustrating the coupling structure of the stand bracket and the stand base of the display apparatus of FIGS. 1, 2, and 5.

### DETAILED DESCRIPTION OF THE PREFERRED EMBODIMENTS

Reference will now be made in detail to the embodiment of the present general inventive concept, examples of which are illustrated in the accompanying drawings, wherein like reference numerals refer to like elements throughout. The embodiment is described below in order to explain the present general inventive concept by referring to the figures.

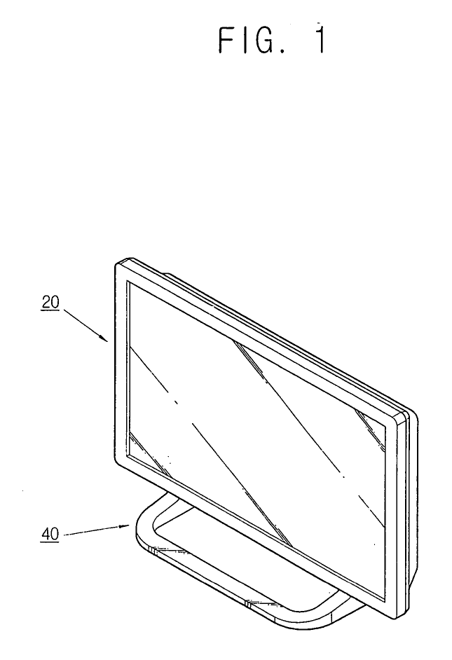

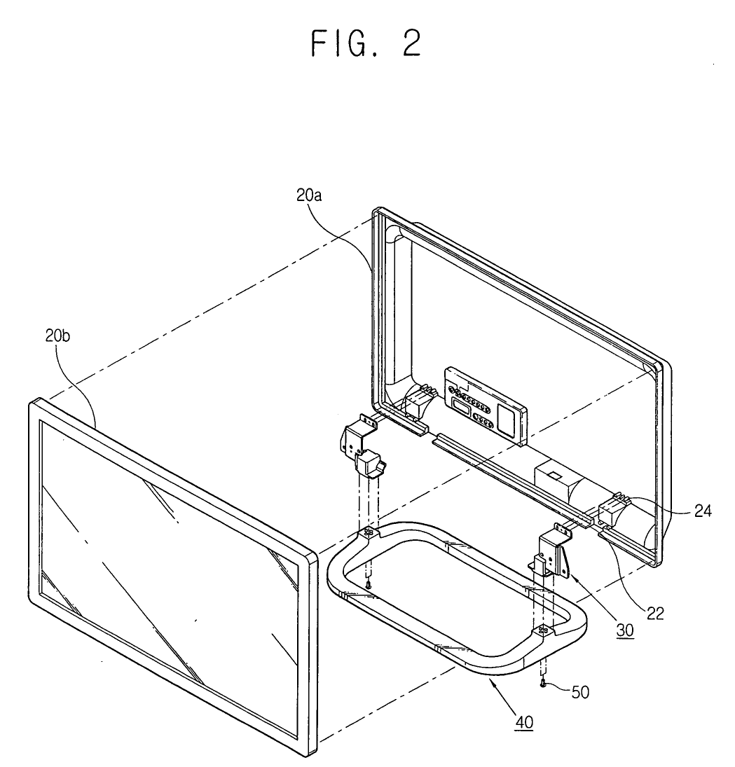

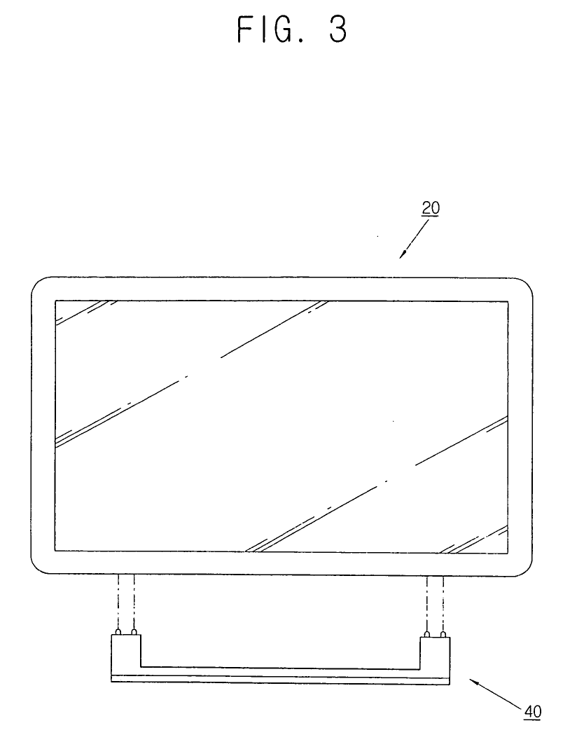

As shown in FIGS. 1 to 3, a display apparatus according to an embodiment of the present general inventive concept may comprise a monitor 20 having a through hole 22, a stand bracket 30 provided inside the monitor 20 and placed adjacent to the through hole 22, a stand base 40 detachably coupled to the stand bracket 30 through the through hole 22 of the monitor 20.

The monitor 20 can display an image on a panel, and the through hole 22 can be provided at each of lower edges (lower rim portions) of the monitor 20. In an inner lower portion of a back case 20a of the monitor 20 can be provided a plurality of bosses 24 to couple the stand bracket 30 thereto.

The stand bracket 30 can be coupled to the monitor 20 and the stand base 40 to enable the monitor 20 to rotate about the stand base 40. Further, one or more stand brackets 30 can be provided in a pair to correspond to the through holes 22 formed at each of the lower edges of the monitor 20 to stably support the monitor 20.

The stand bracket 30 can be placed inside the monitor 20 not to be externally exposed when the stand base 40 is detached from the stand bracket 30. Therefore, although the display apparatus is mounted on a wall, the stand bracket 30 can be protected from being damaged while improving an appearance of the display apparatus.

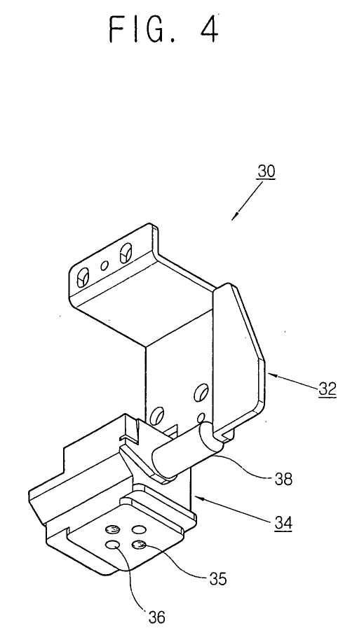

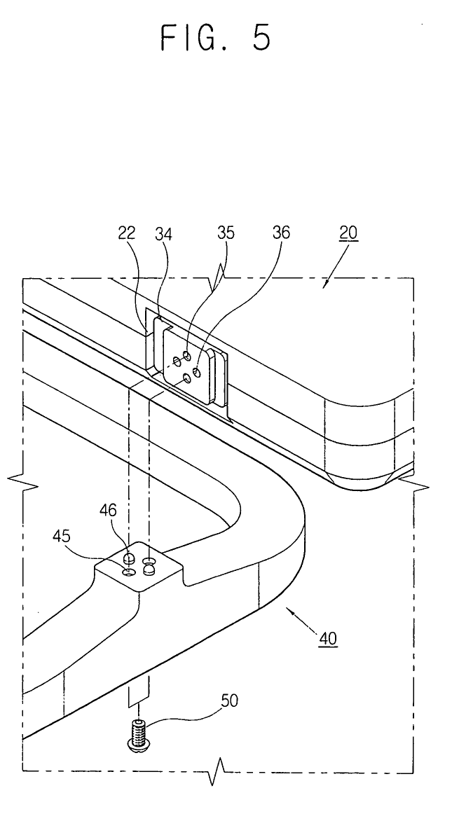

The stand bracket 30 and the stand base 40 may be coupled by a coupling device like a screw 50, and a coupling structure of the stand bracket 30 and the stand base 40 will be describer later, referring to FIGS. 4 and 5.

Meanwhile, a reference numeral 20b denotes a front case which is coupled to the back case 20a of the monitor 20, and a detailed description related thereto will be omitted.

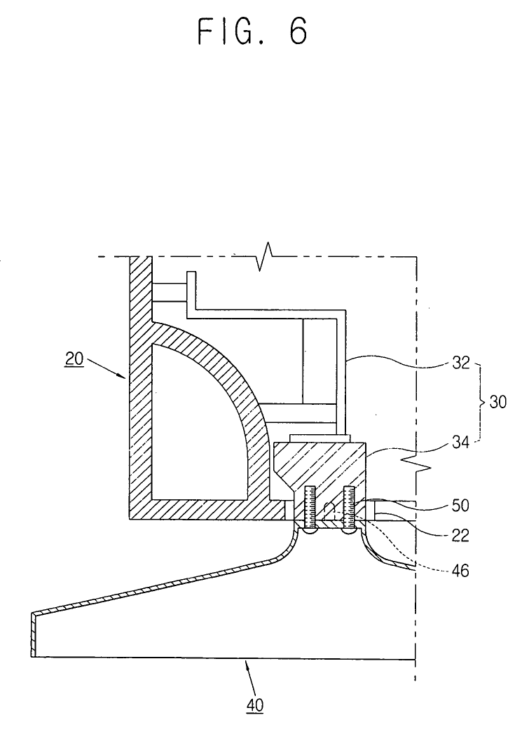

As shown in FIGS. 4 to 6, the stand bracket 30 can support a position of the monitor 20 at a given height and enables the monitor 20 to be tiltable with respect to the stand bracket 30. The stand bracket 30 may comprise a first bracket 32 provided inside the monitor to firmly support the monitor 20, and a second bracket 34 rotatably connected to the first bracket 32 through a shaft 38 and coupled to the stand base 40. When the shaft 38 is fixedly coupled to the first bracket 32, the shaft 30 is rotatably inserted into a hole formed on the second bracket 34. If the shaft 38 is fixedly coupled to the second bracket 34, the shaft 30 is rotatably supported by the first bracket 32.

The first bracket 32 can be rotatable at a given angle with respect to the second bracket 34 according to a titling operation of the monitor 20.

The second bracket 34 can have a structure to cover the through hole 22 of the monitor 20, so that an inside of the monitor 20 is not externally exposed when the stand base 40 is detached from the second bracket 34. Accordingly, an appearance of the display apparatus is improved and the inside of the monitor 20 is protected from being irritated by an external substance which can be introduced into the inside of the monitor.

The second bracket 34 and the stand base 40 may respectively comprise at least one screw groove 35 and one screw through hole 45 formed to correspond to each other, and firmly coupled to each other by the screw 50. The number of screw grooves 35 and the screw through holes 45 can be changed if necessary.

The screw 50 can penetrate the screw through hole 45 from a lower portion of the stand base 40 and can be coupled to the second bracket 34 through the screw groove 35 to enable the stand base 40 to be readily detachable from the second bracket 35.

In a lower portion of the second bracket 34 can be provided at least one guide groove 36, and a guide projection 46 is formed in an upper portion of the stand base 40 corresponding to the guide groove 36 so as to readily couple the stand base 40 to the second bracket 34.

Positions of the guide groove 36 and the guide projection 40 to be formed on the second bracket 34 and the stand base 40, respectively, can be changed if necessary. For example, one of the second bracket 34 and the stand base 40 may have the guide groove 36 and the other one of the second bracket 34 and the stand base 40 may have the guide projection 46 corresponding to the guide groove 36.

As described above, the second bracket 34 can be placed inside the monitor 20 so that the second bracket 34 is not externally exposed through the through hole 22 when the stand base 40 is detached from the second bracket 34. Accordingly, an outer apparatus of the monitor 20 can be improved.

Although an embodiment of the present general inventive concept has been shown and described, it will be appreciated by those skilled in the art that changes may be made in the embodiment without departing from the principles and spirit of the invention, the scope of which is defined in the appended claims and their equivalents.

1. A display apparatus comprising:
a monitor having a through hole;
a stand bracket provided inside the monitor and placed adjacent to the through hole; and
a stand base provided below the monitor and detachably coupled to the stand bracket through the through hole of the monitor.

2. The display apparatus of claim 1, wherein the through hole is formed below the monitor.

3. The display apparatus of claim 2, wherein the stand bracket comprises a first bracket supportably coupled to an inside of the monitor, and a second bracket rotatably coupled to the first bracket and coupled to the stand base.

4. The display apparatus of claim 3, wherein the second bracket and the stand base respectively have at least one screw coupling groove and at least one corresponding screw through hole through which the second bracket and the stand are coupled by a screw.

5. The display apparatus of claim 4, wherein at least one of the second bracket and the stand base comprises a guide groove, and the other one of the second bracket of the stand base comprises a guide projection to correspond to the guide groove.

6. The display apparatus of claim 3, wherein the second bracket is not externally exposed through the through hole of the monitor.

7. The display apparatus of claim 1, wherein the stand bracket comprises a first bracket supportably coupled to an inside of the monitor, and a second bracket rotatably connected to the first bracket and coupled to the stand base.

8. The display apparatus of claim 7, wherein the second bracket and the stand base respectively have at least one screw coupling groove and at lest one corresponding screw through hole through which the second bracket and the stand are coupled by a screw.

9. The display apparatus of claim 8, wherein at least one of the second bracket and the stand base comprises a guide groove, and the other one of the second bracket and the stand base comprises a guide projection to correspond to the guide groove.

10. The display apparatus of claim 7, wherein the second bracket is not externally exposed through the through hole of the monitor.

11. A display apparatus comprising:
a monitor having a case and a through hole formed on the case;
a stand bracket disposed inside of the monitor, and having a first bracket coupled to the case, and a second bracket rotatably coupled to the first bracket and disposed adjacent to the through hole of the case; and
a stand base detachably coupled to the second bracket of the stand bracket through the through hole of the case.

12. The display apparatus of claim 11, wherein the first bracket comprises a first portion coupled to an inside surface of the case, and a second portion extended from the first portion toward the through hole of the case to be rotatably coupled to the second bracket.

13. The display apparatus of claim 11, wherein the through hole comprises a first through hole and a second through hole, and the stand bracket comprises a first stand bracket and a second stand bracket each having the first bracket coupled to the case, and the second bracket rotatably coupled to the first bracket and disposed adjacent to a corresponding one of the first and second through holes of the case.

14. The display apparatus of claim 13, wherein the stand base comprises a first and a second surfaces to be coupled to the second brackets of the first and second stand brackets through the first and second through holes, respectively.

15. The display apparatus of claim 14, wherein the first and second through holes are spaced apart from each other, and the first and second surfaces of the stand base are spaced-apart from each other to correspond to the first and second through holes of the case,

16. The display apparatus of claim 11, wherein the stand bracket comprises a shaft rotatably coupled between the first bracket and the second bracket so that the monitor rotates with respect to the stand base according to an angle between the first bracket and the second bracket.

17. The display apparatus of claim 11, wherein the second bracket of the stand bracket comprises a bracket surface disposed adjacent to the through hole to be coupled to the stand base, and a shape of the bracket surface of the second bracket is substantially the same as that of the through hole so that the through hole is covered by the bracket surface of the second bracket to prevent a foreign material from being introduced into an inside of the case through the through hole.

18. The display apparatus of claim 17, wherein the bracket surface of the second bracket is disposed on a plane of an outer circumference of the case.

19. The display apparatus of claim 11, wherein the stand base comprises a base surface to be coupled to the second bracket of the stand bracket, and a shape of the base surface of the stand base is substantially the same as that of the through hole so that the through hole is covered by the base surface of the stand base to prevent a foreign material from being introduced into an inside of the case through the through hole.

20. The display apparatus of claim 19, wherein the second bracket of the stand bracket does not protrude from the case through the through hole.
